(19) United States
(12) Patent Application Publication
(10) Pub. No.: US 2022/0388336 A1
(43) Pub. Date: Dec. 8, 2022

(54) MULTIPURPOSE AND UNIVERSAL WRENCH

(71) Applicant: David Mosley, Bartlett, TN (US)

(72) Inventor: David Mosley, Bartlett, TN (US)

(21) Appl. No.: 17/831,051

(22) Filed: Jun. 2, 2022

Related U.S. Application Data
(60) Provisional application No. 63/195,913, filed on Jun. 2, 2021.

(51) Int. Cl. B60B 29/00; B25G 1/06; B25B 23/142; B25B 23/18; B25G 1/04

(52) U.S. Cl. CPC B60B 29/003; B25G 1/063; B25B 23/1427; B25B 23/18; B25G 1/043

(57) ABSTRACT

A multipurpose and universal wrench for tightening and loosening a fastener, such as a lug nut. The wrench or lug nut wrench can be adapted to lug nuts of varied sizes and shapes. The wrench includes four arms arranged in a cross shape, and three arms are functional while the fourth arm has a torque adjusting handle. Sockets can be interchangeably coupled to the three functional arms. Moreover, the arms are telescoping allowing changing the effective length of the arms. The two opposite functional arms can pivot for collapsing the wrench for storage.

### CROSS-REFERENCE TO RELATED APPLICATIONS

This application claims priority from a U.S. Provisional Patent Appl. No. 63/195,913 filed on Jun. 2, 2021, which is incorporated herein by reference in its entirety.

### FIELD OF INVENTION

The present invention relates to a torque wrench, and more particularly, the present invention relates to a universal torque wrench that can be adapted to lug nuts of varied sizes and makes.

### BACKGROUND

Changing a tire of a vehicle is a daunting task for vehicle owners. Even for professionals, loosening and tightening the lug nuts can become hard. The major problem with loosening and tightening the lug nuts is the lack of proper tools. The make of lug nuts, such as the size may vary between different models and brands. The user generally has a quite simple wrench that makes loosening a tightened lug nut very hard and often impossible for a very tightly fastened lug nut.

Often, the tire must be changed at night and dark, and the user may lack proper lighting means. Changing the tire in the dark can be more difficult and risky because of the chances of the user getting injured. For example, the wrench may not properly fit around the lug nut and flip upon applying the torque.

Thus, a need is appreciated for a device that allows loosening and tightening the lug nuts easily and comfortably.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a wrench that can be used to fasten and loosen the nuts of different shapes and sizes.

It is another object of the present invention that the wrench can be used in the dark.

It is still another object of the present invention that the wrench allows applying the correct amount of torque.

It is a further object of the present invention that a nut can be easily and safely tightened and loosened.

It is yet another object of the present invention that the wrench can be used to fasten the lug nuts of different vehicles.

It is a further object of the present invention that the wrench can be folded for storage.

It is still a further object of the present invention that the wrench can illuminate the working area.

It is yet a further object of the present invention that the wrench can be increased and decreased in size for variable force.

In one aspect, disclosed is a multipurpose and universal wrench for fastening a fastener, the multipurpose and universal wrench comprises a center portion; a handle arm, a left arm, a right arm, and a main arm those extend from the center portion, wherein adjacent arms are perpendicular to each other, and the left arm and the right arm are opposite to each other; and a plurality of sockets for the left arm, the right arm, and the main arm, wherein each socket of the plurality of sockets is configured to be interchangeably coupled to the respective arm. The left arm and the right arm are pivotally coupled to the center portion, wherein the left arm and the right arm are configured to pivot towards the handle arm. The handle arm has a handle. The handle is configured to allow adjusting an amount of torque that is applied to the fastener by the respective socket. The multipurpose and universal wrench further comprises a housing coupled to the central portion, the housing comprises an illumination means configured to illuminate an area around a socket of the plurality of sockets. The multipurpose and universal wrench further comprises a battery encased within the housing and configured to power the illumination means. The illumination means comprises a plurality of LEDs configured to project a focused beam of light. The multipurpose and universal wrench further comprises a USB port configured in the housing for charging an external electronic device. The multipurpose and universal wrench further comprises one or more solar cells for charging the battery using solar energy. The multipurpose and universal wrench further comprises a blinking strobe light.

In one implementation, each arm of the left arm, the right arm, and the main arm comprises a telescoping mechanism that allows adjusting an effective length of the respective arm. The plurality of sockets are of different sizes. The fastener is a lug nut of a wheel of a vehicle.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a planar view of the wrench, according to an exemplary embodiment of the present invention.

FIG. 2 shows the wrench without sockets, according to an exemplary embodiment of the present invention.

FIG. 3 is a perspective of the housing of the wrench, according to an exemplary embodiment of the present invention.

FIG. 4 is a front view of the housing, according to an exemplary embodiment of the present invention.

FIG. 5 is a rear view of the housing, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Disclosed is a multipurpose and universal wrench that can be used to tighten and loosen nuts without undue force and risk of injury. The disclosed wrench can be used to tight or loose lug nuts while changing a tire of a vehicle. The wrench can be adapted for lug nuts of different shapes and sizes; thus, a single wrench can be used for several types of nuts in different vehicles. Moreover, the size of the wrench can be varied using telescoping arms for variable torque application. The disclosed wrench is compact and can further be folded for storage. The compact and foldable design makes the disclosed wrench easy to carry taking little space for storage. The disclosed wrench can be used to change a tire quickly and easily on cars, trucks, SUVs, and other residential or commercial vehicles.

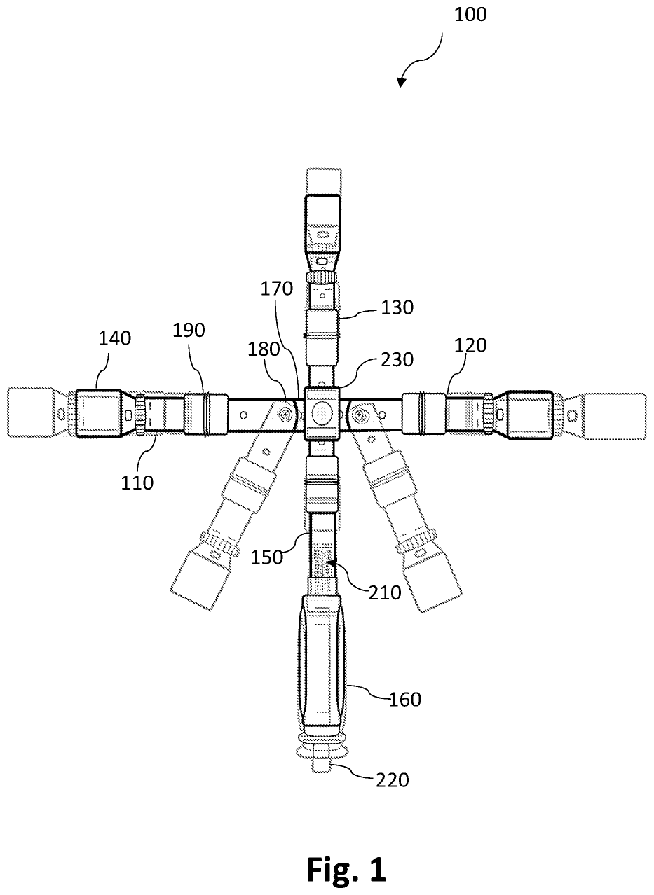

Referring to FIG. 1 shows an exemplary embodiment of the disclosed wrench 100. The wrench 100 can include three functional arms i.e., a left arm 110, a right arm 120, and a main arm 130. Each arm has an interchangeable socket 140. A fourth arm 150 has a handle 160, wherein the four arms are arranged in a cross shape. The adjacent arms are perpendicular to each other. The disclosed three-way wrench can be folded by pivoting the two arms adjacent to the handle arm i.e., the left arm 110 and the right arm 120. FIG. 1 shows the pivoting of the left arm and the right arm in lighter line color, wherein the left arm and the right arm are shown pivoted towards the handle arm. The left arm 110 and the right arm 120 can be coupled to a central portion 170 of the wrench through hinge joints 180 that allows pivoting movement within a predefined range or degree of angle. The pivoting of the two arms can allow the user to vary the force and angle of force that can be applied. The two arms can be pivoted up to the desired angle relative to the handle arm, such that at 30 degrees or 60 degrees. Moreover, the left and right arms can be pivoted up to 90 degrees for folding the disclosed wrench. Suitable locking means can also be provided to limit the pivoting movement of the left and right arms up to the desired angle. The user can grab the left and right arms at desired angles to apply torque to the fastener. In one implementation, the left arm and the right arm can also be removably coupled to the central portion, for example using a screw.

In a preferred embodiment, one or more of the arms of the disclosed wrench can have telescoping members that allow increasing or decreasing the effective length of the arm. Each arm can be independently changed in length to manipulate the torque applied to a fastener using the respective arm. The telescoping arms can make the disclosed wrench compact for storage such that the arms can be retracted for storage and extended for use. Any suitable telescoping mechanism that is known to a skilled person for use in the telescoping shaft, rods, and like can be embodied in the disclosed wrench and any such telescoping mechanism is within the scope of the present invention. Also, a multi-member arm in which a member can be added to increase the effective length of the arm or removed to decrease the effective length of the arm is also within the scope of the present invention. Any of the arms including the handle arm can be telescopic. For example, the effective length of each arm can be extended up to 2-5 inches in length. In one implementation, the telescoping mechanism 190 can include a spring and a metal bead, wherein the arm can be pulled up to the desired length and locked in place by the metal bead.

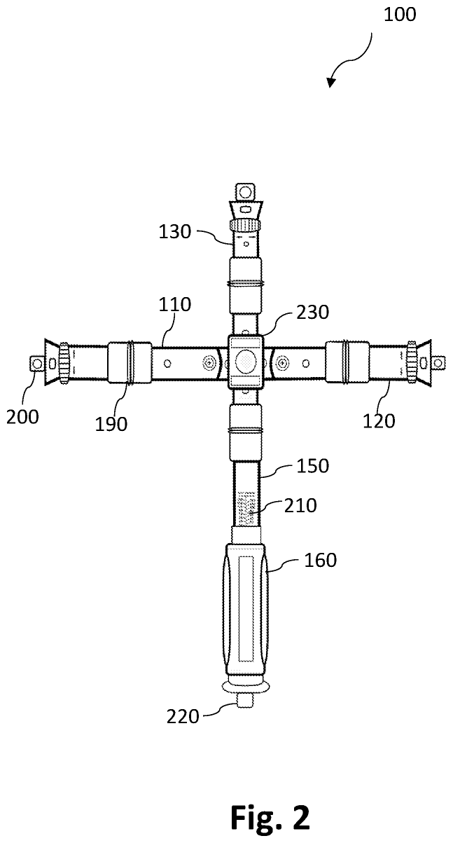

The sockets can be interchangeably attached to the tips of the arms, such that a socket can be removed and replaced by the same or different socket. FIG. 2 shows the wrench 100 without the sockets. Sockets for several types and sizes of nuts can be provided and the user can pick the desired socket and put the same on the disclosed wrench. In one implementation, sockets of standard sizes can be provided, for example, ¾ inches, ½ inches, and ⅜ inches standard size sockets can be provided. The sockets can be directly coupled to the arm or indirectly using an adapter. The adapter can be used to increase the length or change the angle of the socket. For example, 90-degree adapters of diverse sizes can be provided. However, it is understood that adapters of different angles are within the scope of the present invention. In one implementation, the sockets can have a hexagonal mouth for coupling to a hexagonal nut.

A suitable fastening mechanism, such as a rachet and quick release tab can also be provided for interchangeably mounting a socket to the arm. FIG. 2 shows the rachet and quick release tab mechanism 200 at the tips of the left, right, and main arms. It is understood, however, that a different fastening mechanism is within the scope of the present invention.

The disclosed wrench can preferably be used for lug nuts, and so also referred to herein as a lug wrench can have the additional functionality of a torque wrench that allows applying a specific torque to the lug nut. The drive of the torque wrench functionality can be built into the handle arm of the disclosed wrench. Any suitable mechanism of torque wrenches known to a skilled person for applying a specific torque to a fastener can be embodied in the disclosed wrench and any such suitable mechanism is within the scope of the present invention. Using the disclosed wrench, a user can apply a proper amount of torque to fasten the lug nuts while changing a tire of a vehicle. The handle can be used to adjust the torque measurement from torque pounds to newton meters per user requirements. FIGS. 1 and 2 show a torque bar 210 with torque setting in (ft-lb) foot-pound and (N-m) Newton meters. The handle can have a suitable grip, such as a TPR grip for adjusting to suggested torque. A small dial 220 is also shown in the figures that can be used for locking the handle to the suggested torque setting.

Also, the preferred embodiment of the disclosed wrench is described in reference to a lug nut and used for changing the wheel of a vehicle, it is understood, however, that the disclosed wrench can be used to tighten and loosen any other type of nut without departing from the scope of the present invention.

In a preferred embodiment, disclosed is a wrench, also referred to herein as a lug wrench and a three-way lug wrench, which has sockets at three arms to turn a fastener, such as a lug nut. It is understood, however, that the closed sockets can be replaced by any other means known to a skilled person for engaging and turning a nut, without departing from the scope of the present invention. A suitable ratcheting mechanism can also be included in the handle arm that allows the user to pivot the disclosed wrench back and forth to turn the socket on any of the three arms. Optionally, the handle arm can also pivot up to 90 degrees in the middle of its length. In one implementation, the ratchet with 72 teeth ratcheting mechanism in each of the three functional arms with a quick-release tab can be provided.

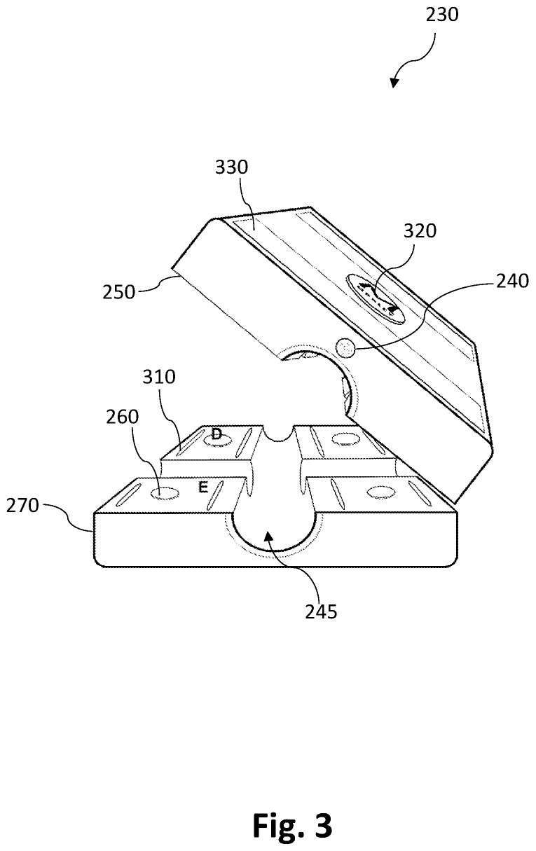

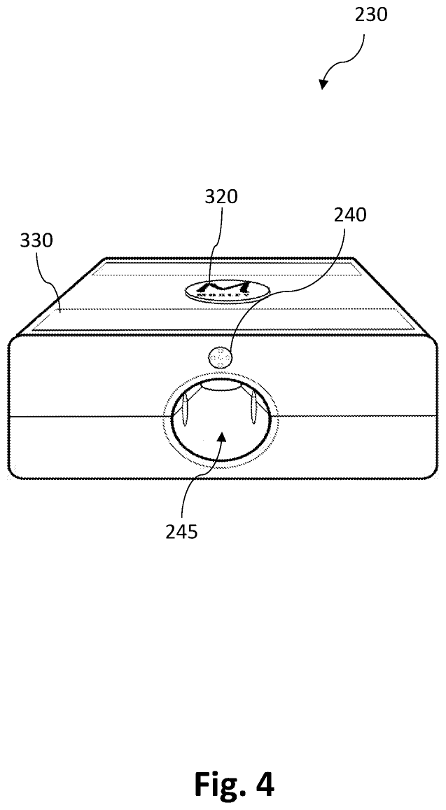

The disclosed wrench can further comprise a housing 230 coupled at the central portion. The housing can include means of illumination for illumination of the working area of the wrench i.e., the area in proximity to the lug nut can be illuminated while working on the lug nut. This allows opening the lug nut in a dark environment easily and significantly reduces the risks of injury. While the socket of the arm is engaged to a lug nut, the illumination means can illuminate the lug nut and the area nearby of the lug nut. The illumination means 240 can be one or more LEDs that can project focused light on a small area. Since the wrench has three sockets and a torque-adjusting handle arm, the housing can be rotated at four intervals at 90 degrees angles. Suitable stops can be provided that can prevent undesired movement of the housing and the housing can be rotated at spaced intervals. The housing can also be removably coupled, such that the housing can be removed and replaced. FIGS. 3-5 shows different views of the housing 230. Housing 230 has an inner void 245 four overlapping to the central portion 170, and lock members to secure the housing 230 by pressing a top member 250 of the housing 230 against the bottom member 270. In one implementation, the lock members can be magnets for securing the top member to the bottom member using magnetic forces. FIG. 3 shows four such magnets 260 on an inner surface of the bottom member 270, however, the number of magnets can vary without departing from the scope of the present invention. Moreover, any other fastening means can be embodied in place of the magnets without departing from the scope of the present invention. Illumination means 240 that includes four LEDs is shown on the front and rear side of the housing, but can be provided on all four sides i.e., the left and right sides as well. The housing can include suitable circuitry for powering the illumination means. The illumination means can be powered by a battery also encased within the housing. The battery can be a disposable battery or a rechargeable battery. In the case of a rechargeable battery, the circuitry encased in the housing can also provide for charging the battery through an external power supply. The external power can be supplied through a wire or wirelessly. Moreover, one or more solar cells can also be provided on the housing to charge the battery using solar energy. In one implementation, one or more arms of the wrench can be planar. FIGS. 1 and 2 show all the arms of planar geometry. Small solar panels can be coupled to the planar arms of the wrench. Besides, the solar panels, small grip plates can also be coupled to the planar arms alone or in combination with the solar panels.

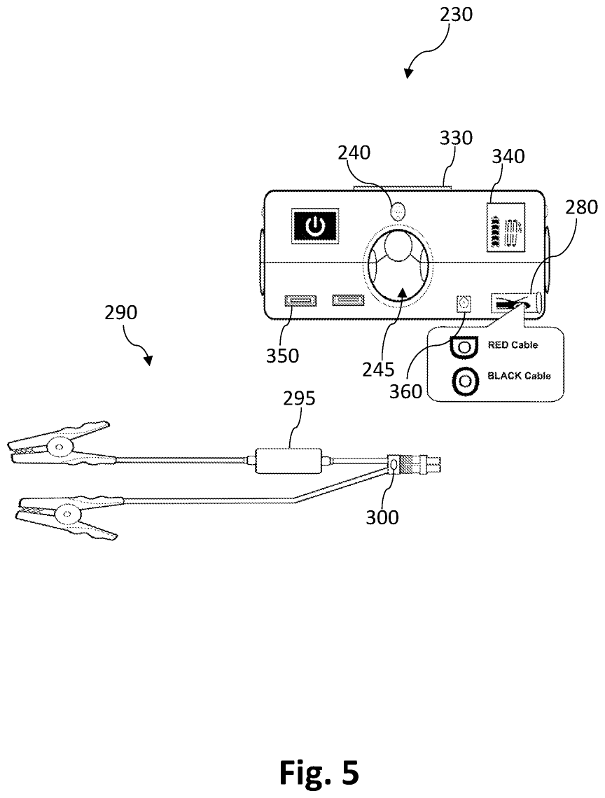

In one implementation, a jump start cable from the vehicle power supply can be used to directly power the illumination means or indirectly by recharging the battery. FIG. 5 shows a socket 280 in the housing 230 for connecting a jump start cable 290 also shown in FIG. 5. The jump start cable can include a module 295 for preventing reverse charge and overload protection. A power indicator 300 near the connector of the jump start cable 290 is also shown which can indicate the correct or bad connection of the jump start cable 290 to the socket 280. The upper member of the housing can be electrically connected to the bottom member using copper pins or strips 310.

The disclosed wrench can also be used as a flashlight. In a preferred embodiment, a blinking strobe light can also be provided on the housing for safety at night. The blinking strobe light can be visible from a far distance, such as to an approaching vehicle, which could prevent a potential collision. An SOS light can also be provided a SOS button 320 is provided for the SOS light (shown in FIG. 3). Another push button 330 shown in FIG. 3 can be used to turn the illumination means on and off. A small display 340 is also shown in FIG. 5 coupled to the housing that shows a digital compass, clock, and battery status. A charging port 350 can also be provided in the housing that allows charging any external electronic device, such as a USB port to charge a smartphone. A DC input 360 for charging the battery is also shown in FIG. 5.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A multipurpose and universal wrench for fastening a fastener, the multipurpose and universal wrench comprises:
a center portion;
a handle arm, a left arm, a right arm, and a main arm those extend from the center portion, wherein adjacent arms are perpendicular to each other, and the left arm and the right arm are opposite to each other; and
a plurality of sockets for the left arm, the right arm, and the main arm, wherein each socket of the plurality of sockets is configured to be interchangeably coupled to the respective arm.

2. The multipurpose and universal wrench according to claim 1, wherein the left arm and the right arm are pivotally coupled to the center portion, wherein the left arm and the right arm are configured to pivot towards the handle arm.

3. The multipurpose and universal wrench according to claim 2, wherein the handle arm has a handle.

4. The multipurpose and universal wrench according to claim 3, wherein the handle is configured to allow adjusting an amount of torque that is applied to the fastener by the respective socket.

5. The multipurpose and universal wrench according to claim 1, wherein the multipurpose and universal wrench further comprises a housing coupled to the central portion, the housing comprises an illumination means configured to illuminate an area around a socket of the plurality of sockets.

6. The multipurpose and universal wrench according to claim 5, wherein the multipurpose and universal wrench further comprises a battery encased within the housing and configured to power the illumination means.

7. The multipurpose and universal wrench according to claim 5, wherein the illumination means comprises a plurality of LEDs configured to project a focused beam of light.

8. The multipurpose and universal wrench according to claim 6, wherein the multipurpose and universal wrench further comprises a USB port configured in the housing for charging an external electronic device.

9. The multipurpose and universal wrench according to claim 6, wherein the multipurpose and universal wrench further comprises one or more solar cells for charging the battery using solar energy.

10. The multipurpose and universal wrench according to claim 6, wherein the multipurpose and universal wrench further comprises a blinking strobe light.

11. The multipurpose and universal wrench according to claim 1, wherein each arm of the left arm, the right arm, and the main arm comprises a telescoping mechanism that allows adjusting an effective length of the respective arm.

12. The multipurpose and universal wrench according to claim 1, wherein the plurality of sockets are of different sizes.

13. The multipurpose and universal wrench according to claim 1, wherein the fastener is a lug nut of a wheel of a vehicle.
